(19) United States
(12) Patent Application Publication
(10) Pub. No.: US 2019/0392422 A1
(43) Pub. Date: Dec. 26, 2019

(54) MOBILE TERMINAL AND CONTROL METHOD THEREFOR

(71) Applicant: LG ELECTRONICS INC., Seoul (KR)

(72) Inventor: Soyeon YIM, Seoul (KR)

(73) Assignee: LG ELECTRONICS INC., Seoul (KR)

(21) Appl. No.: 16/468,207

(22) PCT Filed: Jan. 9, 2017
(86) PCT No.: PCT/KR2017/000283

§ 371 Date: Jun. 10, 2019

(30) Foreign Application Priority Data
Dec. 9, 2016 (KR) 10-2016-0167448

(51) Int. Cl. G06Q 20/32; H04W 4/02; G06Q 20/40; G06Q 20/38

(52) U.S. Cl. CPC G06Q 20/3274; H04W 4/026; G06Q 20/409; G06K 19/06028; G06Q 20/40145; G06Q 2220/00; G06Q 20/3829

(57) ABSTRACT

The present invention relates to a mobile terminal and a method for controlling the mobile terminal. According to the present invention, when a mobile terminal executes a payment function, card information related to a registered card is provided differently according to a posture of the mobile terminal. Therefore, the present invention can solve a security vulnerability of a mobile payment in an easier and more convenient method.

### Technical Field

The present invention relates to a mobile terminal and, more particularly, to a mobile terminal with a payment function and a method for controlling the same.

### Background Art

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As functions of the terminal become more diversified, the terminal can support more complicated functions such as capturing images or video, reproducing music or video files, playing games, receiving broadcast signals, and the like. By comprehensively and collectively implementing such functions, the mobile terminal may be embodied in the form of a multimedia player or a device.

Efforts are ongoing to support and increase the functionality of mobile terminals. Such efforts include software and hardware improvements, as well as changes and improvements in the structural components.

Recent portable terminals can contain user authentication information so that it can be used for online and offline payments. For example, a portable terminal may contain credit card information, etc., and the portable terminal can therefore be used as a credit card even if the user does not carry their credit card with them.

Thus, if a portable terminal comes with a credit card function, a payment function can be performed through the portable terminal using various methods of communication. Also, there is a need to increase the convenience of using the portable terminal by getting the payment function to work in conjunction with various functions that can be implemented through the portable terminal.

Meanwhile, the security of private information needs to be considered from a more variety of perspectives when performing a payment function using a portable terminal compared to when making payment offline.

### DISCLOSURE

### Technical Problem

An aspect of the present invention is to provide a mobile terminal that provides a user interface for allowing a user to control the mobile terminal easily and efficiently, and a method for controlling the mobile terminal.

Another aspect of the present invention is to provide a mobile terminal that can improve security and convenience when performing a payment function using a mobile payment application, and a method for controlling the mobile terminal.

Another aspect of the present invention is to provide a mobile terminal that can improve security and convenience by detecting a change in the position of the mobile terminal when performing a payment function using a mobile payment application, and a method for controlling the mobile terminal.

Another aspect of the present invention is to provide a mobile terminal that can improve security and convenience by taking a fingerprint authentication pattern into consideration when performing a payment function using a mobile payment application, and a method for controlling the mobile terminal.

Another aspect of the present invention is to provide a mobile terminal that can improve security and convenience by taking location information into consideration when performing a payment function using a mobile payment application, and a method for controlling the mobile terminal.

Another aspect of the present invention is to provide a mobile terminal that allows for more convenient use of a variety of payment methods by detecting a change in the position of the mobile terminal when performing a payment function using a mobile payment application, and a method for controlling the mobile terminal.

### Technical Solution

A mobile terminal according to an exemplary embodiment of the present invention may include: a body; a display provided on the front of the body; a position detection sensor for detecting the position of the body or a change in the position of the body; a memory for storing card information for executing a payment function; and a controller that, when the payment application is executed, identifies the orientation of the display as a first direction or second direction through the position detection sensor, and that displays first card information on the display in the first direction and displays second card information, which is created by encrypting at least part of the first card information, on the display in the second direction.

The orientation of the display may be a direction perpendicular to the plane of the display.

The display may include a touch panel, and the controller may disable a touch response function of the touch panel in the second direction.

The first direction may be a direction in which the display is oriented at a point in time when the payment application is executed, and the second direction may include at least one between a direction in which the display is oriented when tilted at a predetermined angle from the first direction with respect to one axis of the body and substantially the opposite direction of the first direction.

The first card information may include at least one among a card company, a card number, a card validity date, the name of the card holder, and balance information, and the second card information may include at least one between information created by encrypting some of the first card information required for payment and a signature field.

The second card information may include at least one between a barcode and QR code which are provided by encrypting the information required for payment.

If the orientation of the display is switched from the second direction to the first direction when the second card information is displayed, the controller may display the first card information, instead of the second card information, on the display.

If card information on a plurality of cards is registered in the memory, the controller may scroll first card information on each of the plurality of cards through a predetermined input in the first direction and display the same on the display.

The mobile terminal may further include a fingerprint input unit, wherein, when the payment application is executed, if an authentication key inputted through the fingerprint input unit matches a predetermined authentication key, the controller may display the first card information on the display in the first direction, and, if the orientation of the display is switched from the first direction to the second direction while the input on the fingerprint input unit is maintained, the controller may display the second card information on the display.

The controller may display the second card information on the display while the input on the fingerprint input unit is maintained in the second direction, and may make the barcode disappear when the input on the fingerprint input is released.

If the input on the finger input unit is released, the controller may switch the mobile terminal to a locked state and display a lock screen on the display.

If an authentication key is inputted through the fingerprint input unit when the body is at a first terminal position, the controller may display the first card information on the display, and if the authentication key is inputted through the fingerprint input unit when the body is at a second terminal position, the controller may display the second card information on the display.

The fingerprint input unit may include at least one among a key provided on the front of the body, a key provided on the side, a key provided on the rear, and at least some region of a panel of the display.

The mobile terminal may further include a location information module for acquiring location information of the mobile terminal,

wherein, if the payment function is performed when the second card information is displayed on the display, the place of payment acquired through the location information module, along with a payment history, may be stored in the memory.

If it is determined that the payment application is executed at the place of payment within a predetermined period of time after a payment is made at the place of payment, the controller may display the payment history made at the place of payment, instead of the first card information, on the display in the first direction.

Upon detecting that the orientation of the display is switched to the second direction while the payment history is displayed on the display, the controller may display card information for cancelling the payment on the display.

The mobile terminal may further include a location mobile terminal for acquiring location information of the mobile terminal, wherein, upon detecting a predetermined pattern of movement on the body when the payment application is executed and the orientation of the display is maintained in the first direction, the controller may display on the display an up-to-the minute history of payments made at the placement of payment acquired through the location information module.

If the orientation of the display is switched from the second direction to a third direction, the controller may change the method of payment and display a user interface for the changed method of payment on the display. Here, the first direction may be a direction in which the display is oriented at a point in time when the payment application is executed, the second direction may be a direction in which the display is oriented when tilted at a predetermined first angle from the first direction with respect to one axis of the body, and the third direction may be a direction in which the display is oriented when tilted at more than the first angle from the second direction.

The method of payment may include at least one among near field communication (NFC) payment, magnetic reading type payment, and barcode scanning payment.

The mobile terminal may further include a camera, wherein, upon completion of user authentication using an image acquired through the camera when the payment application is executed, the controller may display the first card information on the display in the first direction.

The position detection sensor may include at least one between an acceleration sensor and a gyro sensor.

A method for controlling a mobile terminal according to another exemplary embodiment of the present invention may include: executing a payment application; identifying the orientation of a display provided on the front of a body as a first direction or second direction through a position detection sensor; displaying first card information on the display in the first direction; and, if the orientation of the display is switched from the first direction to the second direction, displaying second card information, which is created by encrypting at least part of the first card information, on the display.

### Advantageous Effects

The mobile terminal and control method for the mobile terminal according to the present invention has the following advantages.

According to the present invention, a user interface can be provided which allows a user to control the mobile terminal easily and efficiently.

Furthermore, according to the present invention, security and safety can be improved when performing a payment function using a mobile payment application.

Furthermore, according to the present invention, security and convenience can be improved by detecting a change in the position of the mobile terminal when performing a payment function using a mobile payment application.

Furthermore, according to the present invention, security and convenience can be improved by taking a fingerprint authentication pattern into consideration when performing a payment function using a mobile payment application.

Furthermore, according to the present invention, security and convenience can be improved by taking location information into consideration when performing a payment function using a mobile payment application.

Furthermore, according to the present invention, variety of payment methods can be used more conveniently by detecting a change in the position of the mobile terminal when performing a payment function using a mobile payment application.

Furthermore, according to the present invention, a desired menu function can be executed more conveniently through a change in the position of the mobile terminal, rather than going through a plurality of depths to execute a variety of menu functions, when performing a payment function using a mobile payment application.

### DESCRIPTION OF DRAWINGS

FIG. 1a is a block diagram of a mobile terminal in accordance with the present disclosure.

FIGS. 1b and 1c are conceptual views of one example of a mobile terminal in accordance with the present disclosure when viewed from different directions.

FIG. 2 is a conceptual view illustrating that a mobile terminal in accordance with the present disclosure is in communication to perform a payment function.

FIG. 3 is a block diagram for explaining in more details at least part of the payment system shown in FIG. 2.

FIGS. 4 and 5 are flowcharts of a control method for a mobile terminal according to a first exemplary embodiment of the present invention.

FIGS. 6 and 7 are views for explaining an example of card information displayed on the display when a payment application is executed in an exemplary embodiment of the present invention.

FIGS. 8 and 9 are views for explaining an example in which different card information is provided depending on the position of the mobile terminal according to the first exemplary embodiment of the present invention.

FIGS. 10 to 12 are views for explaining in more concrete details a change in the position of the mobile terminal and card information provided depending on the change in the position according to the first exemplary embodiment of the present invention.

FIG. 13 is a view for explaining whether touch interaction is enabled or not depending on the position of the mobile terminal according to the first exemplary embodiment of the present invention.

FIG. 14 is a view for explaining another example of implementing the control method for a mobile terminal according to the first exemplary embodiment of the present invention.

FIGS. 15a and 15b are views for explaining the exemplary embodiment of the present invention illustrated in FIG. 14.

FIG. 16 is a flowchart of a control method for a mobile terminal according to a second exemplary embodiment of the present invention.

FIGS. 17a to 17c are views for explaining examples of implementing the control method for a mobile terminal according to the second exemplary embodiment of the present invention.

FIG. 18 is a flowchart of a control method for a mobile terminal according to a third exemplary embodiment of the present invention.

FIG. 19 is a view for explaining an example of implementing the control method for a mobile terminal according to the third exemplary embodiment of the present invention.

FIG. 20 is a flowchart of a control method for a mobile terminal according to a fourth exemplary embodiment of the present invention.

FIGS. 21a and 21b are views for explaining examples of implementing the control method for a mobile terminal according to the fourth exemplary embodiment of the present invention.

FIG. 22 is a flowchart of a control method for a mobile terminal according to a fifth exemplary embodiment of the present invention.

FIG. 23 is a view for explaining an example of implementing the control method for a mobile terminal according to the fifth exemplary embodiment of the present invention.

FIGS. 24 and 25 are views for explaining an example of implementing the control method for a mobile terminal according to a sixth exemplary embodiment of the present invention.

### MODE FOR INVENTION

Hereinafter, a mobile terminal relating to the present invention is described in more detail with reference to the drawings. The suffixes “module” and “unit” for components used in the description below are assigned or mixed in consideration of easiness in writing the specification and, do not have distinctive meanings or roles by themselves. In the following description, detailed descriptions of well-known functions or constructions will be omitted since they would obscure the invention in unnecessary detail. Additionally, the accompanying drawings are provided to make embodiments of the present invention clear and the technical ideal of the present invention is not limited to the accompanying drawings. It should be understood that the idea and technical scope of the present invention includes all modifications, equivalents and substitutes.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

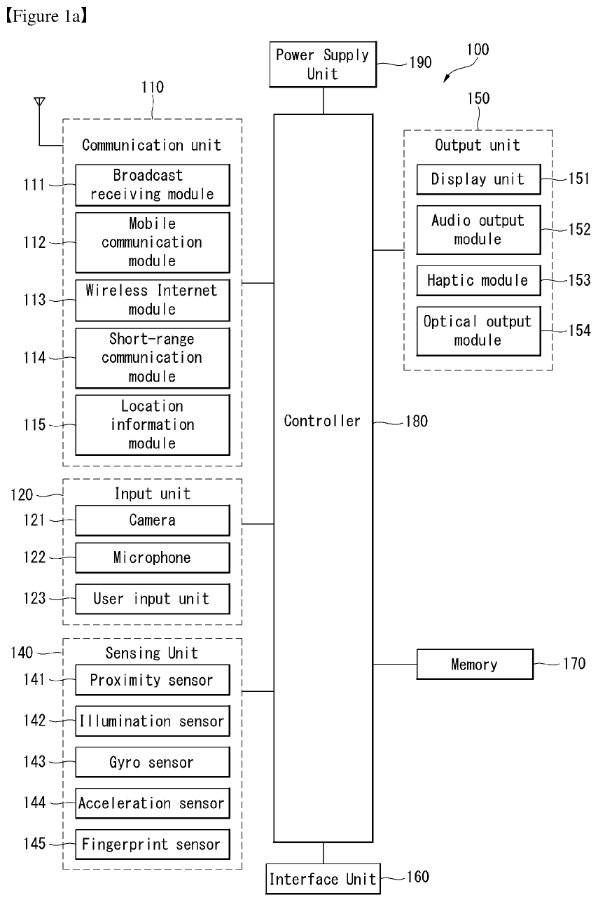

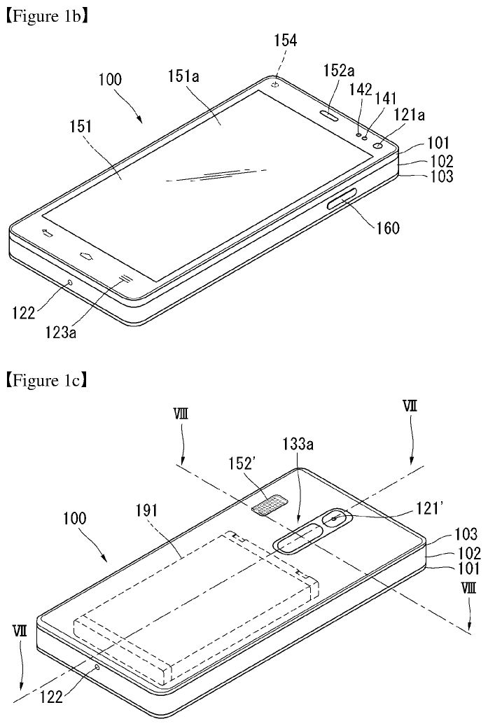

Referring to FIGS. 1a to 1c, FIG. 1a is a block diagram of a mobile terminal in accordance with the present disclosure, and FIGS. 1b and 1c are conceptual views of one example of a mobile terminal in accordance with the present disclosure when viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1a, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1a, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1a, or activating application programs stored in the memory 170.

As one example, the controller 180 controls some or all of the components illustrated in FIGS. 1a-1c according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the above components may work in cooperation with one another in order to implement the operation, control, or control method of the mobile terminal according to various exemplary embodiments to be described below. Moreover, the operation, control, or control method of the mobile terminal may be implemented on the mobile terminal by running at least one application program stored in the memory 170.

Referring still to FIG. 1a, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO(Enhanced Voice-Data Optimized or Enhanced Voice-Data Only), Wideband CDMA (WCDMA), High Speed Downlink Packet access (HSDPA), HSUPA(High Speed Uplink Packet Access), Long Term Evolution (LTE), LTE-A(Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA(High Speed Uplink Packet Access), Long Term Evolution (LTE), LTE-A(Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB(Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches include a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The position detection sensor may detect movement information such as the movement, distance, speed, acceleration, direction, etc. of the mobile terminal 100 and/or position information such as the angle at which the mobile terminal 100 is tilted with respect to a predetermined axis of rotation.

The position detection sensor 143 may be configured to include at least one acceleration sensor 144, at least one gyroscope (gyro sensor 143), or a sensing signal processor (not shown) for compensating for a sensing value or converting sensing information.

The position detection sensor may acquire linear movement, rotational movement, wobbling information, etc. of the mobile terminal 100 based on an acceleration detected through various types of sensors. The acceleration sensor 144 detects movement of the mobile terminal 100, acquires an acceleration thereof, and detects information about the movement, distance, speed, acceleration, direction, etc. of the mobile terminal 100.

Moreover, the gyro sensor 143 may acquire the amount of rotation by detecting rotation of the mobile terminal 100. The acceleration sensor 143 may represent a detected acceleration as a vector for three axes (X-axis, Y-axis, and Z-axis), and the gyroscope may represent a detected acceleration as a rotation vector (roll, pitch, and yaw) for three axes. By having the acceleration sensor 144 and the gyro sensor 143, the position detection sensor may find a speed, position, and positional change of the mobile terminal 100. The position detection sensor may be a typical inertial navigation system (INS), and the gyro sensor may be an optical, mechanical, or piezoelectric gyroscope.

Meanwhile, the sensing signal processor (not shown) may convert an analog signal outputted from the acceleration sensor or gyroscope into an analog/digital signal and convert it into movement information, angle information, wobbling information, etc. by integrating the converted signal and then keeping track of the trajectory.

While a position detection sensor including the acceleration sensor 144 and the gyro sensor 143 to acquire the position and movement of the mobile terminal 100 has been mentioned above according to an exemplary embodiment of the present invention, the present invention is not limited thereto, and the movement and position information of the mobile terminal 100 may be acquired using an arbitrary sensor within a range in which the purpose of the invention can be achieved.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1b and 1c, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

As the mobile terminal 100 is viewed herein as at least one assembly, the terminal body may be understood as a concept for it.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include the display unit 151, first and second audio output modules 152a and 152b, the proximity sensor 141, the illumination sensor 142, the optical output module 154, the first and second cameras 121a and 121b, first and second manipulation units 123a and 123b, the microphone 122, the interface unit 160, and so on.

As shown in FIGS. 1b and 1c, a description will be given below with respect to the mobile terminal 100 in which the display unit 151, first audio output module 152a, proximity sensor 141, illumination sensor 142, optical output module 154, first camera 121a, and first manipulation unit 123a are arranged on the front of the terminal body, the second manipulation unit 123b, microphone 122, and interface unit 160 are arranged on the side of the terminal body, and the second audio output module 152b and second camera 121b are arranged on the rear of the terminal body.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. For example, the display unit 151 may display execution screen information of an application program running on the mobile terminal 100 or UI (User Interface) and GUI (Graphic User Interface) information based on such execution screen information.

Examples of the display unit 151 include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1b illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

Meanwhile, a rear input unit 133a, as another example of the user input unit 123, may be provided on the rear of the terminal body. Such a rear input unit is manipulated to receive commands for controlling the operation of the mobile terminal 100, and inputs may be set in various ways. For example, commands such as power on/off, start, end, and scroll, control commands for the level of sound outputted from the first and second audio output modules 152a and 152b, and command such as conversion of the display unit 151 to the touch recognition mode may be received. The rear input unit may be implemented in such a manner as to enable touch input, push input, and a combination thereof.

The rear input unit 133a may be configured to overlap the display unit 151 on the front in the thickness direction of the terminal body. In an example, the rear input unit may be placed on the rear upper edge of the terminal body so that the user can easily manipulate the terminal body with an index finger when gripping it in one hand. However, the present invention is not necessarily limited thereto, and the position of the rear input unit may be changed.

In the case where the rear input unit 133a is provided on the rear of the terminal body, a new type of user interface may be implemented using it. Moreover, the above-explained touchscreen or rear input unit may replace at least some of the functions of the first manipulation unit 123a provided on the front of the terminal body, so the display unit 151 may be configured as a larger screen if the first manipulation unit 123a is not provided on the front of the terminal body.

Meanwhile, the mobile terminal 100 may include a fingerprint recognition sensor for recognizing a user's fingerprint, and the controller 180 may use fingerprint information detected through the fingerprint recognition sensor as a means of authentication. The fingerprint recognition sensor may be embedded in the display unit 151 and the user input unit 123. Moreover, the rear input unit 133a may include a panel for fingerprint recognition, and the fingerprint recognition sensor may be integrated with the panel and embedded in the rear input unit 133a.

The microphone 122 is configured to receive the user's voice and other sounds. The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1c, a flash 124 is shown adjacent to the second camera 121b. When an image of a subject is captured with the camera 121b, the flash 124 may illuminate the subject.

As shown in FIG. 1b, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

As aforementioned with reference to FIG. 1a, short-range communication technologies such as Bluetooth™, RFID (Radio Frequency Identification, Infrared Data Association (IrDA), UWB (Ultra Wideband), ZigBee, NFC (Near Field Communication), and Wireless USB (Wireless Universal Serial Bus) may be applicable to the mobile terminal according to the present invention.

An NFC module provided at the mobile terminal supports non-contact short-range wireless communication between mobile terminals within about 10 cm. The NFC module may operate in one among a card mode, a reader mode and a P2P mode. The mobile terminal 100 may further include a security module for storing card information, in order to operate the NFC module in a card mode. The security module may be a physical medium such as UICC (Universal Integrated Circuit Card) (e.g., SIM (Subscriber Identification Module) or USIM (Universal SIM)), a secure micro SD, and a sticker, or a logical medium (e.g., embedded SE (Secure Element)) embedded in the mobile terminal. SWP (Single Wire Protocol)-based data exchange may be performed between the NFC module and the security module.

When the NFC module operates in a card mode, the mobile terminal may transmit card information on a general IC card to the outside. More specifically, if a mobile terminal having therein card information on a payment card (e. g, a credit card or a bus card) is made to approach to a card reader, a short-range mobile payment may be executed. On the other hand, if a mobile terminal which stores card information on an entrance card is made to approach to an entrance card reader, an entrance approval procedure may start. A card such as a credit card, a traffic card and an entrance card may be mounted in the security module in the form of applet, and the security module may store card information on the card mounted therein. Card information of a payment card may be at least one of a card number, balance, and a usage history. Card information of an entrance card may be at least one of a user's name, a user's number (e.g., undergraduate number or staff number) and an entrance history.

When the NFC module operates in a reader mode, the mobile terminal may read data from an external tag. The data received from the external tag by the mobile terminal may be coded into the NFC Data Exchange Format defined by the NFC Forum. The NFC Forum defines four record types. More specifically, the NFC Forum defines four RTDs (Record Type Definitions) such as Smart Poster, Text, URI (Uniform Resource Identifier) and General Control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or originate a call. If the data received from the external tag is a general control type, the controller may execute a proper operation according to control content.

When the NFC module operates in a peer-to-peer (P2P) mode, the mobile terminal may execute P2P communication with another mobile terminal. In this case, LLCP (Logical Link Control Protocol) may be applied to the P2P communication. For the P2P communication, connection may be generated between the mobile terminal and the another mobile terminal. The connection may be categorized into a connectionless mode which ends after one packet is switched, and a connection-oriented mode in which packets are switched consecutively. For the P2P communication, data such as an electronic type name card, address information, a digital photo and a URL, a setup parameter for Bluetooth connection, Wi-Fi connection, etc. may be switched. The P2P mode can be effectively utilized in switching data of a small capacity, because an available distance for NFC communication is short.

For convenience of explanation, it is assumed that a mobile terminal according to one exemplary embodiment of the present invention includes at least one of the components illustrated in FIGS. 1a to 1c. For example, a mobile terminal according to exemplary embodiments to be described later may be defined as including the wireless communication unit 110, camera 121, sensing nit 140, display unit 151, memory 170, and controller 180 among the components illustrated in FIGS. 1a to 1c.

In this case, the wireless communication unit 110 may include a communication module for communication between the mobile terminal 100 and a payment terminal.

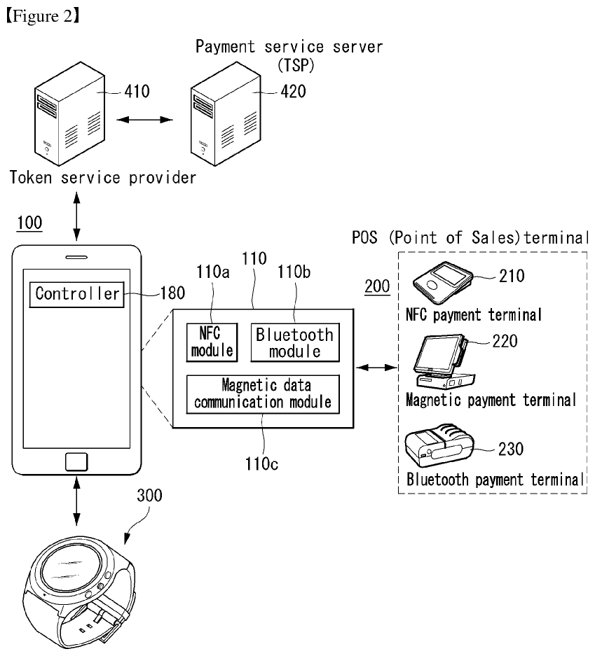

FIG. 2 is a block diagram illustrating a payment system for making payment according to an exemplary embodiment of the present invention.

Referring to FIG. 2, the payment system may include a mobile terminal 100 including a wireless communication unit 100 for performing wireless communication with a payment terminal, a POS terminal 200, a payment service server 410, and a token service provider (TSP) 420. Further, the payment system may include one or more additional electronic devices 300. The one or more additional electronic devices 300 may include a wearable device 300 (e.g., smartwatch) functionally connectable to the mobile terminal 100 or a predetermined accessary (not shown) supporting the mobile payment function of the mobile terminal 100.

The accessory may include a loop pay for supporting magnetic payment. If the accessory is used, the mobile terminal 100 be functionally connected to the accessory (e.g., Loop pay) via a predetermined input/output interface (e.g., earphone port).

The mobile terminal 100 may perform a payment function. The mobile terminal 100 may register a card (e.g., Mastercard, Visa Card, or debit card) for performing a payment function on the mobile terminal 100 or payment service server 410.

The mobile terminal 100 may perform communication with the POS terminal 200 through the wireless communication unit 110 in order to perform the payment function.

The wireless communication unit 110 may include at least one among the NFC module 110a, a Bluetooth module 110b, and a magnetic communication module 110c.

Further, the POS terminal 200 may include at least one among the NFC payment terminal 210, a Bluetooth (e.g., BLE (Bluetooth Low Energy) payment terminal 220, and a magnetic payment terminal 230.

The NFC module 110a is for performing communication with the NFC payment terminal 210 using NFC technology. For example, the NFC module 110a of the mobile terminal 100 may be set to a card emulation mode, and the NFC payment terminal 210 may be set to a reader mode. This way, the NFC payment terminal 210 may acquire card information registered in the mobile terminal 100 from the NFC module 110a of the mobile terminal 100. Moreover, the NFC module 110a and the NFC payment terminal 210 both may be set to a P2P mode, for example, to communicate with each other.

The Bluetooth module 110b is for performing communication with the Bluetooth payment terminal using Bluetooth technology. For example, when the Bluetooth module 110b of the mobile terminal 100 receives a beacon signal from the Bluetooth payment terminal 220, it may establish an association with the payment terminal based on the received beacon signal. Then, the mobile terminal 100 may transmit the card information registered in the mobile terminal 100 to the Bluetooth payment terminal 220 through the Bluetooth module 110b.

The magnetic communication module 110c is for performing communication with the payment terminal 230 having a magnetic reader. When a card to use is selected, the mobile terminal 100 may broadcast the card information of the selected card through the magnetic communication module 110c. The magnetic payment terminal 230 may listen to data broadcasted by the mobile terminal 100, thereby proceeding with payment between the mobile terminal 100 and the magnetic payment terminal 230.

The payment service server 410 may manage information on a plurality of registered cards, including cards registered through the mobile terminal 100 and other cards registered through another electronic device 300 (e.g., smartwatch) of the user corresponding to the mobile terminal 100 or through other users' electronic devices.

For example, the payment service server 410 may acquire token information corresponding to registered card information from the token service provider 420 and deliver it to the mobile terminal 100.

The token service provider 420 may issue tokens used in a payment process. Token-type data may include token information and cryptogram information. The token information may include card identification ID information received from a card company, and the cryptogram information may include transaction data. The transaction data may include one or more between the expiration date of a card used for payment and identification ID information of a card affiliate received from the POS terminal.

An issued token may be encrypted by the token service provider 420, or EH may be transmitted without being encrypted to the payment service server 410 and then encrypted by the payment service server 410. The encrypted token information may be delivered to the mobile terminal 100 through the payment service server 410 and then decrypted by the mobile terminal 100. Alternatively, the token may be created and encrypted by the token service provider 420 and then delivered to the mobile terminal 100 without going through the payment service server 410.

Meanwhile, the payment service server 410 may include a token creation function, in which case the token service provider 420 may not be used in the payment system.

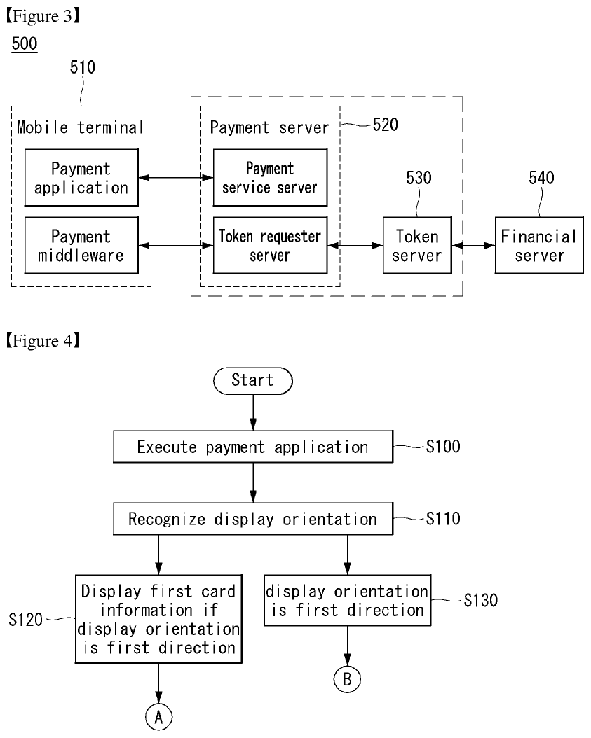

FIG. 3 is a block diagram for explaining in more details at least part of the payment system shown in FIG. 2.

Referring to FIG. 3, the payment system according to an exemplary embodiment of the present invention may include a mobile terminal 510 and/or a server.

The server may include a payment server 520, a token server (token service provider) 530, and a financial server (issuer).

The mobile terminal 100 may include a payment application (wallet application) and/or payment middleware. Further, the payment server 520 may include a payment service server and/or a token requester server (token requester).

The payment application may provide a user interface related to mobile payment. The user interface related to payment may include a wallet user interface (wallet UI/UX). For example, the payment application may provide a user interface related to card registration, payment, or transaction.

The payment application may provide an interface related to card registration, for example, via optical character reader/recognition (OCR) or via external input (user input).

Moreover, the payment application may provide an interface related to user authentication. For example, a variety of interfaces related to user authentication may be provided depending on the method of authentication, and an interface for password input-based authentication or biometric information-based authentication (e.g., fingerprint authentication and iris authentication) may be provided.

Regarding the interface depending on the method of authentication, the mobile terminal 100 (see FIG. 1) may further include a camera 121 for recognizing a user's iris or a fingerprint input unit for receiving a user's fingerprint.

The fingerprint input unit may be layered with a button (e.g., home button exposed to the front of the mobile terminal) provided on the mobile terminal 100 (see FIG. 1). In this case, when the user pushes the home button, the user input pushing the home button and the user's fingerprint may be received simultaneously. To prevent unnecessary power consumption, the controller 180 may control the fingerprint input unit to activate it when the button layered with the fingerprint input unit is pushed. Aside from the aforementioned button structure, if the fingerprint input unit is designed in such a way as to be integrated with a touchscreen so that a certain area or entire area on the touchscreen operates as a fingerprint detection sensor, fingerprint input may be detected via a touch input on a certain area on the touchscreen.

The payment middleware may include information related to a card company. For example, the payment middleware may include a card company SDK (software development kit).

Meanwhile, the payment server 520 may send and receive information between the mobile terminal 100 and the token server 530 by using a payment service server and/or token requester server. The payment service server may include, for example, a payment server (e.g., LG payment server), and may manage card information associated with a service account (e.g., LG account) or user account. Further, the payment service server may include an API (Application Program Interface) server related to the payment application. Moreover, the payment service server may provide an account management module (account interaction).

The token requester server may provide an interface for processing information related to payment. For example, the token requester server may issue, delete, or activate information related to payment (e.g., tokens). Moreover, the token requester server may be functionally connected to the payment middleware and control the information required for payment.

The payment application included in the mobile terminal 510 and the payment service server included in the payment server may be functionally connected. For example, the payment application may send and receive information related to payment to and from the payment server. Moreover, the payment middleware may be functionally connected to the token requester server included in the payment server. For example, the payment middleware may send and receive information related to payment to the token requester server.

The token server 530 may issue a token related to payment or manage information related to payment. For example, the token server 530 may manage the life cycle of the token, and the life cycle may include a token creation, modification or deletion function.

The payment server 520 and/or token server 530 may be located in an integrated area or in separate areas. For example, the payment server 520 may be included in a first server, and the token server 530 may be included in a second server. Moreover, the payment server 520 and/or token server 530 may be implemented separately in one server.

The financial server 530 may issue a card. For example, the financial server may include a card issuing bank. Moreover, it may create information required for payment which is provided to the user. The user may store the information required for payment created by the financial server 540 in the mobile terminal 510 by using the payment application. In addition, the financial server 540 may be functionally connected to the token server 530 and send and receive the information required for payment.

In accordance with an exemplary embodiment of the present invention, a different user interface containing card information provided by the payment application may be provided depending on the position of the mobile terminal 510, thereby improving security vulnerability.

Meanwhile, in one exemplary embodiment of the present invention, a method of executing a payment application, detecting the position of the mobile terminal 100 or a change in the position thereof, and outputting card information for payment on the display depending on the position of the mobile terminal 100 will be described in concrete details through the exemplary embodiments to be described later.

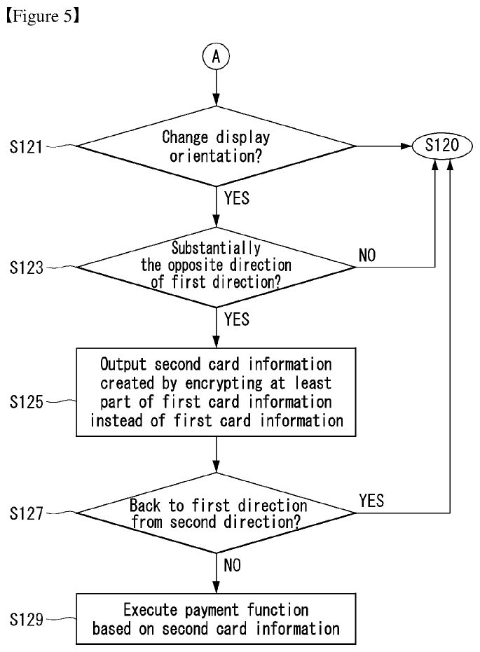

FIGS. 4 and 5 are flowcharts of a control method for a mobile terminal according to a first exemplary embodiment of the present invention.

The control method for a mobile terminal according to the first exemplary embodiment of the present invention may be implemented on the mobile terminal 100 explained with reference to FIGS. 1a to 3. Hereinafter, a control method for an electronic device according to the first exemplary embodiment of the present invention and an operation of the mobile terminal 100 for implementing the same will be described in detail with reference to the required drawings.

Referring to FIG. 4, the controller 180 may execute a payment application (S100).

Once at least one card is registered through the payment application, first card information corresponding to the at least one registered card and a second card for making payment using the card may be provided. The card may include a credit card (Visa card or Mastercard) or a debit card.

According to an exemplary embodiment of the present invention, the first card information may include a card company, a card number, a card validity date, the name of the card holder, and, if the card has a limit, balance information. Moreover, the second card information may include information created by encrypting some of the first card information that is required for payment. For example, if payment is made by code information scanning, the card number and validity date in the first card information may be encrypted into the second card information and outputted as a barcode or QR code. Moreover, when payment is made by short-range communication (NFC), an alarm or the like for inducing NFC tagging may be outputted on the display, without the need to encrypt at least part of the first card information.

In the aforementioned example, the second card information has been described by taking a barcode, QR code, etc. as an example; however, the present invention is not limited thereto. For example, it should be noted that any type of information required for a payment terminal to perform payment may be contained as long as the second card information explained in an exemplary embodiment of the present invention does not contain private information (card number, etc.).

Here, since the first card information contains private information or the like, the mobile terminal 100 needs to be configured in such a way that only the user can see the first card information, in order to increase security when performing payment using a mobile payment application. On the other hand, the second card information required for actual payment does not provide private information, so there would be no problem with security in executing the mobile payment application even if the second card information is exposed to a third-party.

Thus, if the user of the mobile terminal is looking at the display at a point in time when the payment application is executed, there is no problem in outputting the first card information. On the other hand, if a third person is looking at the display, the user is construed as having the intention of performing actual payment, rather than showing card information containing their private information, and there is a need to output the second card information on the display. Accordingly, an exemplary embodiment of the present invention may provide the first card information or second card information selectively to the display by taking the execution of the payment application and the position of the mobile terminal into consideration.

Here, the position of the mobile terminal may refer to the display orientation. The display orientation may refer to a direction perpendicular to the plane of the display. Here, the direction perpendicular to the display plane may be retrieved by detecting the current position of the mobile terminal by the position detection sensor (acceleration sensor and/or gyro sensor) of the mobile terminal 100. The position detection sensor (acceleration sensor and gyro sensor) is the same as what has been described previously.

The controller 180 may recognize the position (i.e., display orientation) when the payment application is executed (S110).

In an exemplary embodiment of the present invention, the display orientation may be identified as a first direction or second direction.

The first direction may be a direction in which the display is oriented at a point in time when the payment application is executed, and the second direction may be a direction to which the display orientation is changed from the first direction based on a predetermined criterion. For example, if the payment application is executed while the user is looking at the display, the display may face in the first direction, or if the mobile terminal is rotated and forms 180 degrees from the first direction, the display may face in the second direction.

The definitions of the first and second directions are not limited to the aforementioned examples, but it should be noted that the display orientation may be defined as the first direction as long as the display is viewed as oriented toward the user of the mobile terminal, and that the display orientation may be defined as the second direction as long as the display is viewed as oriented toward a third person.

Moreover, while the aforementioned example (first exemplary embodiment of the present invention) has been described with respect to a method of detecting the first and second directions by the position detection sensor (acceleration sensor and/or gyro sensor) of the mobile terminal, the present invention is not limited thereto. For example, when the payment application is executed, the mobile terminal may distinguish the first and second directions via user authentication or via user images taken through the camera. Other examples will be described below, in which the first card information or second card information is selectively provided by distinguishing the first and second directions, rather than through the position detection sensor.

If the controller 180 identifies the display orientation as the first direction, the first card information may be displayed on the display 151 (hereinafter, referred to as touchscreen) (S120). As described above, the first direction may correspond to a direction in which the user is looking at the display.

If the controller 180 identifies the display orientation as the second direction, the second card information may be displayed on the touchscreen 151 (S130). As described above, the second direction may be a direction in which a third person other than the user is looking at the display, and the third person may be positioned opposite the user.

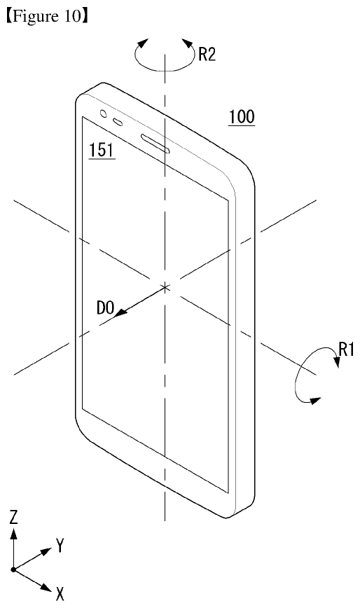

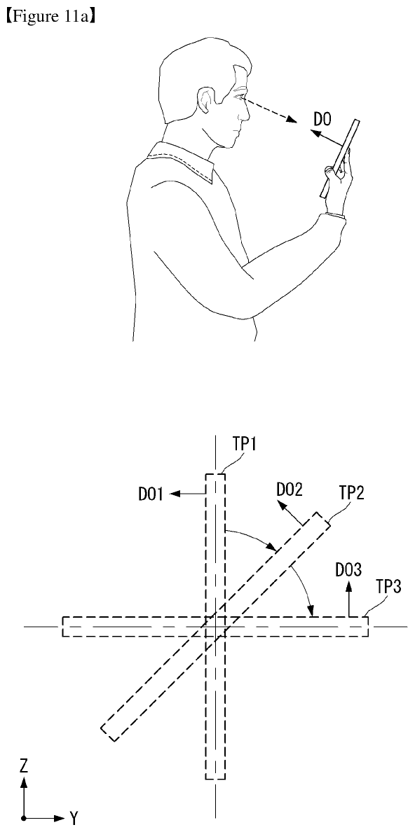

Here, if the second direction is a direction opposite the user, the first and second directions may not be limited to forming precisely 180 degrees. The ranges of the first and second directions will be described in more details with reference to FIGS. 10 to 12.

In FIG. 5, the exemplary embodiment illustrated in FIG. 4 will be described in more details with reference to an example in which the display orientation is changed.

Referring to FIG. 5, when the orientation of the display 151 is the first direction and first card information is displayed on the touchscreen 151 (S120 of FIG. 4), the controller 180 may detect whether the display orientation is changed or not (S121).

If the controller 180 determines that the orientation of the display 151 is substantially the opposite direction of the first direction (S123:YES), second card information, which is created by encrypting at least part of the first card information displayed on the touchscreen 151, instead of the first card information, may be outputted on the touchscreen 151 (S125).

Here, substantially the opposite direction of the first direction reefers to a direction that forms 180 degrees from the first direction. Also, if the first direction is rotated at a predetermined angle and the user cannot accurately identify information provided on the display 151 any longer, this means that the display 151 is oriented in the second direction.

Meanwhile, if the controller 180 detects that the orientation of the display 151 is changed back to the first direction from the second direction (S127:YES), while the display is oriented in the second direction and the second card information is being outputted, the first cad information, instead of the second card information, may be displayed again on the touchscreen 151 (S120).

Meanwhile, the controller may perform a payment function via interaction with a payment terminal while the display 151 is oriented in the second direction. Upon receiving a payment request signal from the payment terminal, the controller 180 may execute the payment function based on the second card information (S129). That is, the user may perform the payment function conveniently without the risk of exposing private information, while looking at the display 151.

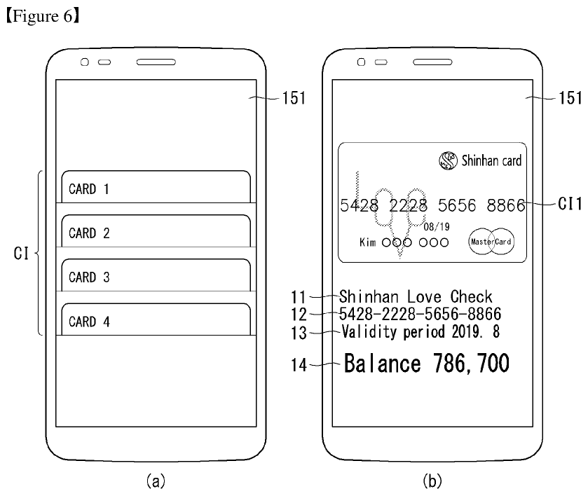

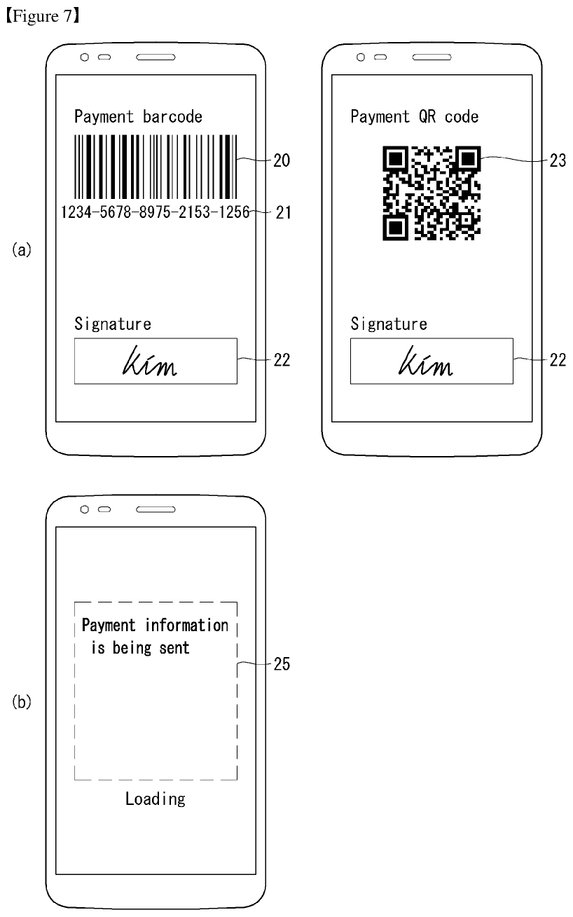

Hereinafter, an example in which the first card information and second card information are displayed will be described with reference to FIGS. 6 and 7.

FIGS. 6 and 7 are views for explaining an example of card information displayed on the display when a payment application is executed in an exemplary embodiment of the present invention.

Referring to FIG. 6, the aforementioned first card information may include private information that requires security. When a payment application is executed, the controller 180 may provide at least one card image CI registered by the user to the touchscreen 151 ((a) of FIG. 6).

Referring to (b) of FIG. 6, the controller 180 may display card information (first card information) corresponding to a selected card image among the at least one card image CI on the touchscreen 151. The first card information may include at least one among the selected card image CI1, a card name 11, a card number 12, a validity period 13, and balance information 14. Among the first card information, the card number 12, validity period 13, and balance information 14 may be information the user must enter or refer to in actually performing a payment function. Especially when a mobile payment is made, the user does not actually go through a process of entering a card number, but an encryption process may be required since there is a substantial risk that the above private information could be exposed to a third person.

Referring to FIG. 7, the aforementioned second card information may include information created by encrypting at least part of the first card information. In an example, the aforementioned card number 12, validity period 13, etc. may be encrypted.

After encryption, the controller 180 may display a payment barcode 20 and a barcode number 21 corresponding to the payment barcode as the second card information on the touchscreen 151. In addition, the controller 180 may provide a signature field 22. Also, the controller 180 may provide a QR code instead of the barcode ((a) of FIG. 7). The barcode and the QR code are information scanned through a payment terminal, which may be examples of the second card information provided when payment is made by scanning.

Meanwhile, if a preset method of payment is NFC, the NFC module (110a of FIG. 2) provided on the mobile terminal 100 may be set to a card emulation mode, and the NFC payment terminal (210 of FIG. 2) may be set to a reader mode. Thus, the second card information may be represented as information for tapping the mobile terminal 100 to the NFC payment terminal 210. The same may apply when the present method of payment is MST ((b) of FIG. 7).

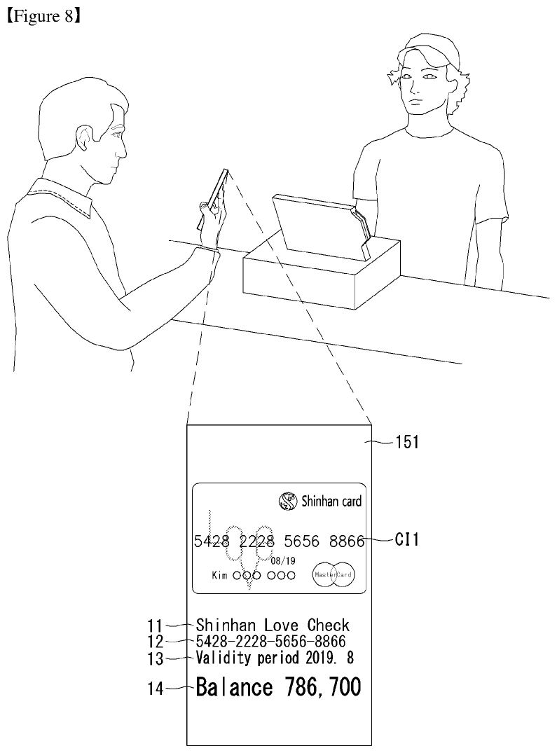

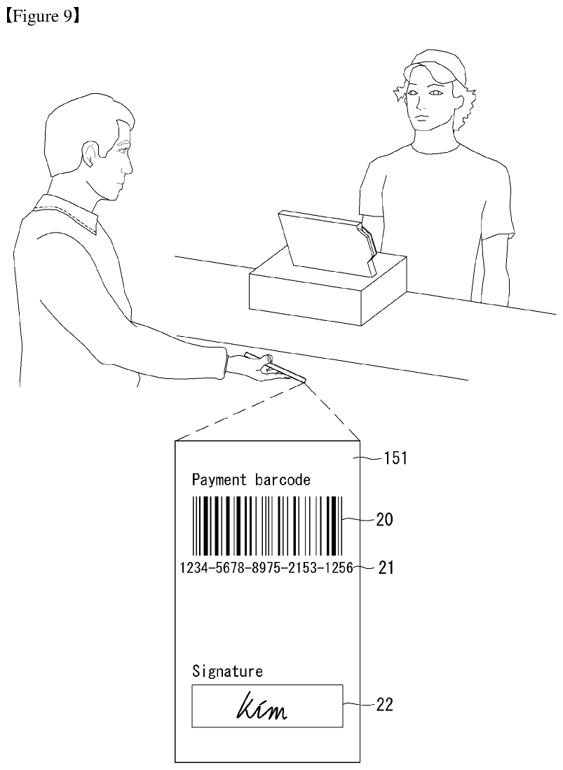

FIGS. 8 and 9 are views for explaining an example in which different card information is provided depending on the position of the mobile terminal according to the first exemplary embodiment of the present invention.

The mobile terminal 100 may be positioned between the owner of the mobile terminal 100 and the other party for payment.

Referring to FIG. 8, if the orientation of the display 151 is identified as a direction (first direction) toward the owner of the mobile terminal 100 when the mobile terminal 100 is running a payment application, the aforementioned first card information may be displayed on the touchscreen 151. Also, referring to FIG. 9, if the controller 180 determines that the orientation of the display 151 is a direction (second direction) toward the other party for payment, the aforementioned second card information may be displayed on the touchscreen 151.

Hereinafter, a method of identifying the aforementioned display orientation as a first direction or second direction will be described.

FIGS. 10 to 12 are views for explaining in more concrete details a change in the position of the mobile terminal and card information provided depending on the change in the position according to the first exemplary embodiment of the present invention.

Referring to FIG. 10, the display 151′s orientation (DO) may be defined as a Y-axis direction perpendicular to the plane of the display 151.

In this instance, the position detection sensor (acceleration sensor and/or gyro sensor) may detect that the upper and lower bodies of the mobile terminal 100 are rotating (R1) with respect to the X-axis so as to move in opposite directions. Upon detecting the rotation by the position detection sensor, the display orientation DO is changed.

Moreover, the position detection sensor (acceleration sensor and/or gyro sensor) may detect that the left and right bodies of the mobile terminal 100 are rotating (R2) with respect to the Z-axis so as to move in opposite directions. Likewise, the display orientation DO may be changed.

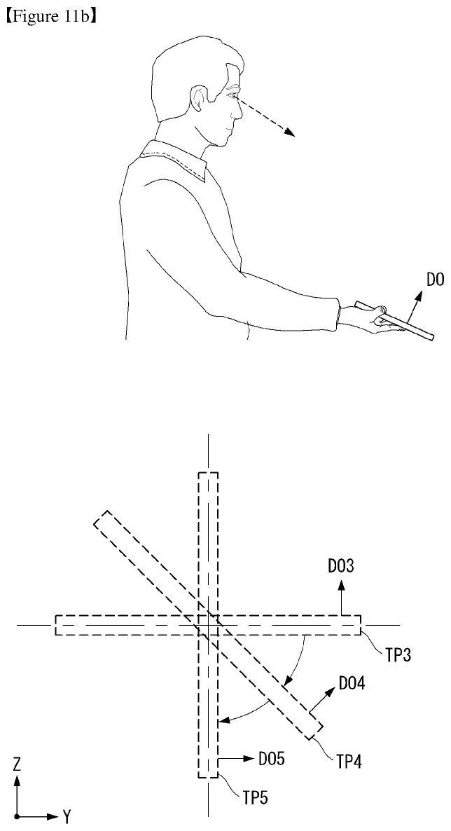

FIG. 11a is a view for explaining the range of the first direction in which the aforementioned display orientation DO may be identified as a first direction.

Referring to FIG. 11a, the position of the mobile terminal 100 may be changed due to a rotation of the mobile terminal 100 with respect to the X-axis when viewed from the side. For example, if the mobile terminal 100 is positioned at a first terminal position TP1, the display orientation DO1 may be the first direction. If the position of the mobile terminal 100 is tilted at 45 degrees (second terminal position TP2), the display orientation DO2 may be included in the first direction. In this instance, the controller 180 may recognize the display orientation DO3 corresponding to when the mobile terminal 100 is tilted further up to 90 degrees (third terminal position TP3) as a threshold display orientation DO3. That is, if the position of the mobile terminal is rotated beyond the third terminal position TP3, the controller 180 may identify the display orientation as the second direction.

Thus, the controller 180 may identify the display orientation ranging from DO1 to DO3 as the first direction, and if the display orientation is within the range from DO1 to DO3 as the position of the mobile terminal 100 is changed, the first card information may be displayed on the touchscreen 151 within that range.

That is, if the mobile terminal 100 is positioned at the third terminal position TP3, the controller 180 may determine that the information displayed on the display 151 cannot be perceived clearly in the user's field of vision and the information is exposed to the other party.

Referring to FIG. 11b, the position of the mobile terminal 100 in FIG. 11a may be rotated further from the third terminal position TP3 with respect to the X-axis, and reach a fourth terminal position TP4 and then to a fifth terminal position TP5. In response to the rotation, the controller 180 may recognize the display orientation DO within the range from DO3 up to DO4 and DO5. Thus, if the display orientation is within the range from DO3 to DO5, the controller 180 may identify the display orientation as the second direction and display the second card information on the touchscreen 151 within that range.

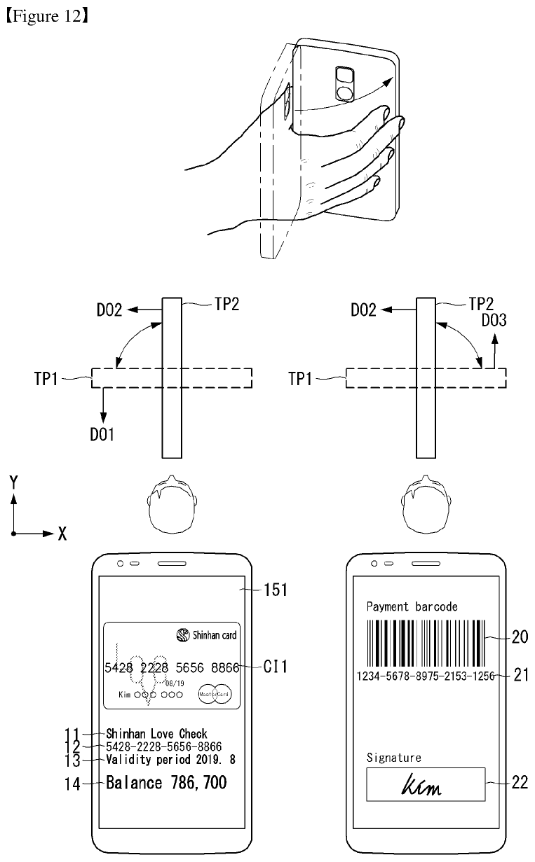

The ranges of the first and second directions when the position of the mobile terminal 100 rotates with respect to the Z-axis will be described with reference to FIG. 12.

Referring to FIG. 12, when the mobile terminal 100 is at the first terminal position TP1, the orientation DO1 of the display 151 may be toward the user's eye. In this instance, if the mobile terminal 100 rotates 90 degrees with respect to the Z-axis and reaches the second terminal position TP2, the orientation DO2 of the display 151 may be perpendicular to the orientation at the second terminal position TP1. With the orientation DO2 of the display at the second terminal position, the user cannot substantially see the information displayed on the display 151. Therefore, when the mobile terminal 100 is positioned at the second terminal position TP2, the controller 180 may identify the display orientation DO2 as a threshold display orientation DO2, and if the display orientation DO ranges between DO1 and DO2, the aforementioned first card information may be displayed on the touchscreen 151.

Likewise, if the mobile terminal 100 is positioned at the third terminal position TP3 beyond the second terminal position TP2, the controller 180 may display the aforementioned second card information on the touchscreen 151 if the display orientation DO ranges between DO2 and DO3.

In the process of recognizing the display orientation DO through the position TP of the mobile terminal 100 and a change in the position thereof that have been explained with reference to FIGS. 11a to 12, sensing may be done by the position detection sensor (acceleration sensor and/or gyro sensor).

Meanwhile, in FIGS. 11a to 12, the description of a change in the position of the mobile terminal 100 and a change in the display orientation depending on the position change is merely an illustration, and the present invention is not limited thereto. For example, while FIGS. 11a and 11b illustrate a rotation with respect to the X-axis and FIG. 12 illustrates a rotation with respect to the Z-axis, it should be noted that the present invention may encompass a rotation with respect the direction of the vector for a combination of the X- and Z-axes and also may encompass the amount of change in the display orientation with a real-time change in the direction of a vector for the combination of the X- and Z-axes. Moreover, such a change in the display orientation may be acquired by the aforementioned position detection sensor.

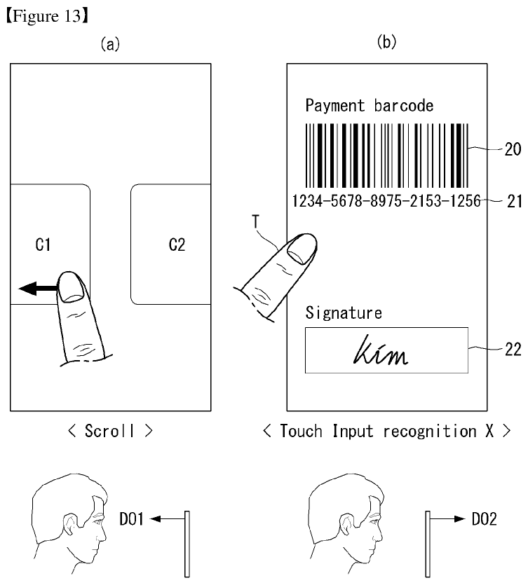

FIG. 13 is a view for explaining whether touch interaction is enabled or not depending on the position of the mobile terminal according to the first exemplary embodiment of the present invention.

Referring to FIG. 13, the controller 180 may selectively change the touch response function of the touchscreen 151 depending on the orientation of the display 151. For example, if the orientation of the display 151 is the first direction DO1 in which the mobile terminal 100 faces the user, the controller 180 performs control to respond to a touch input on the touchscreen 151.

Accordingly, upon receiving a touch drag input while first card information is being displayed on the touchscreen 151, the controller 180 may sequentially scroll a plurality of card images and display them on the touchscreen 151.

On the contrary, if the orientation of the display 151 is the second direction DO2 in which the user of the mobile terminal 100 faces the other party, the controller 180 disables the touch response function of the touchscreen 151. Thus, the controller 180 may not response to a touch input while second card information is being displayed on the touchscreen 151. Accordingly, if the orientation of the display 151 is the second direction, security may be improved in performing a payment function through a mobile payment application.

Meanwhile, according to the above-described first exemplary embodiment of the present invention, a description has been made on the assumption that the orientation of the display 151 is identified as a first direction or second direction at a point in time when a payment application is executed. However, the present invention is not limited to this. For example, when a payment application is executed according to an exemplary embodiment of the present invention, a user authentication process may be additionally required. Therefore, it can be assumed that, after the payment application is executed, the orientation of the display is identified as a first direction or second direction at a point in time when user authentication is completed, so as to selectively provide first card information and second card information.

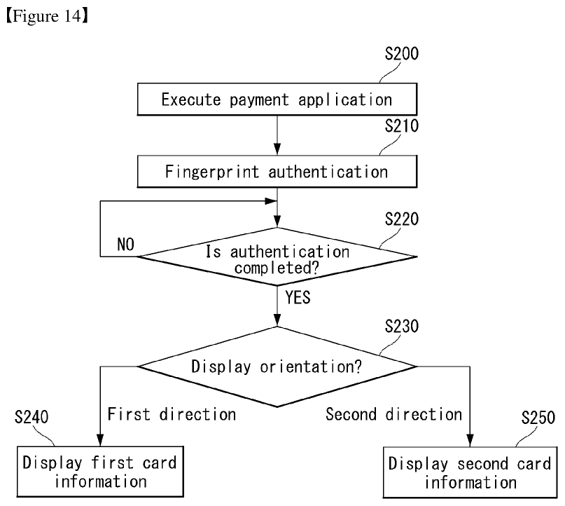

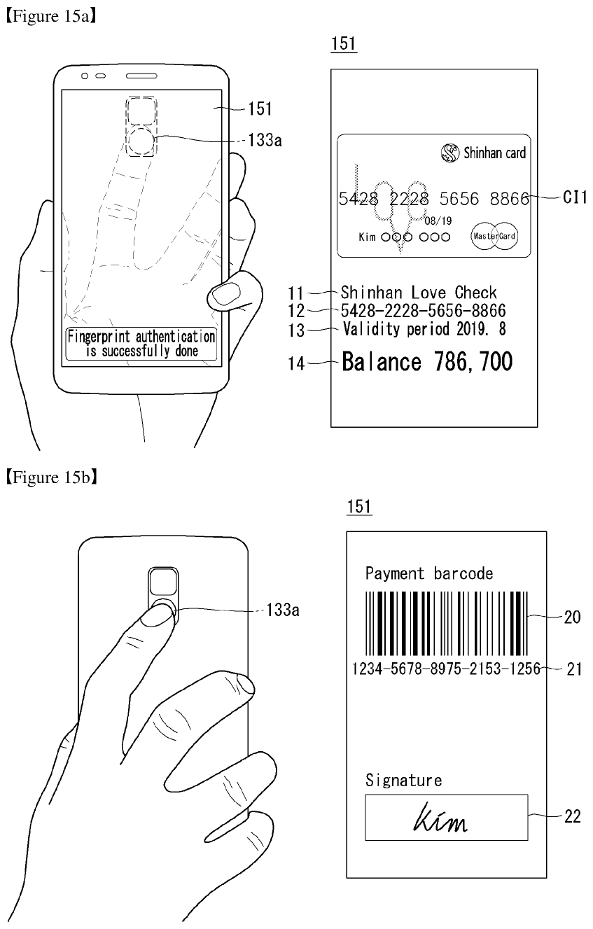

FIG. 14 is a view for explaining another example of implementing the control method for a mobile terminal according to the first exemplary embodiment of the present invention. FIGS. 15a and 15b are views for explaining the exemplary embodiment of the present invention illustrated in FIG. 14.

Referring to FIG. 14, the controller 180 may execute a payment application (S200).

As the payment application is executed, an interface for user authentication may be provided to the touchscreen 151. According to the first exemplary embodiment of the present invention, at least one card image registered after completion of the user authentication process may be displayed on the touchscreen 151, and an input for selecting a particular card image may be received. The user authentication will be described by taking fingerprint authentication as an example.

The controller 180 may receive a user's fingerprint input via the user interface for fingerprint authentication—for example, a fingerprint recognition area (not shown) displayed in a specific region on the touchscreen 151 or a home key provided on the front of the body or the rear input unit (133a of FIG. 1c).

The controller 180 may perform a fingerprint authentication process by comparing the received fingerprint input with registered user fingerprint information (S210). Once the fingerprint authentication is completed (S220:Y)—that is, if the received fingerprint information matches predetermined fingerprint information, the controller 180 may identify whether the display orientation is a first direction or second direction (S230). As stated previously, the display orientation may be detected by the position detection sensor (acceleration sensor and/or gyro sensor).

Referring to FIGS. 15a and 15b, it is assumed that the user interface for fingerprint input is the rear input unit 133a provided on the rear of the mobile terminal 100.

If the orientation of the display 151 is identified as the first direction, the controller 180 may display the first card information on the touchscreen 151 (S240 in FIG. 15a), and if the orientation of the display 151 is identified as the second direction, the controller 180 may display the second card information on the touchscreen 151 (S250 in FIG. 15b).

Accordingly, if the orientation of the display 151 is the second direction at a point in time when a payment application is executed but fingerprint authentication is not made, neither the first card information nor the second card information may be displayed on the touchscreen 151. If fingerprint authentication is completed while the display 151 is oriented in the second direction, the second card information may be provided immediately on the touchscreen 151 without the process of displaying the first card information.

Meanwhile, if the orientation of the display 151 is switched from the first direction to the second direction while an input on the fingerprint input unit is maintained, the second card information, instead of the first card information, may be displayed on the touchscreen 151.

Moreover, when the orientation of the display 151 is the second direction, the controller 180 may provide the second card information to the touchscreen 151 only while an input on the fingerprint input unit is maintained, and, if the input on the fingerprint input unit (an input from the user's finger) is released, the controller 180 may make the second card information disappear.

In addition, if the input on the fingerprint input unit is released in the second direction, the controller 180 may switch the mobile terminal 100 to a locked state and provide a lock screen to the touchscreen 151. Accordingly, it is possible to prevent any exposure of private information which may occur when the fingerprint input is released while the display 151 is oriented in the second direction.

The first exemplary embodiment of the present invention has been described above with respect to an example in which the direction of the display is identified as a first direction or second direction after execution of a payment application and/or fingerprint authentication, or in which either the first card information or second card information is selectively provided by taking into consideration a change from the first direction to the second direction or a change from the second direction to the first direction.

Hereinafter, a second exemplary embodiment of the present invention will be described with respect to an example in which different card information is provided based on the direction of a fingerprint input recognized in a fingerprint authentication process.

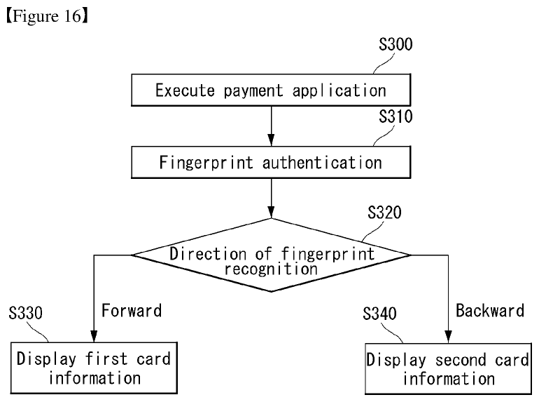

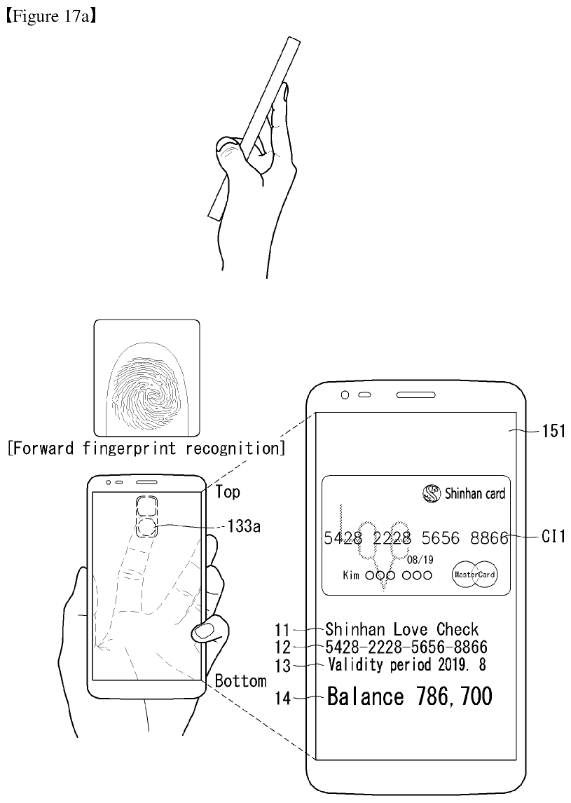

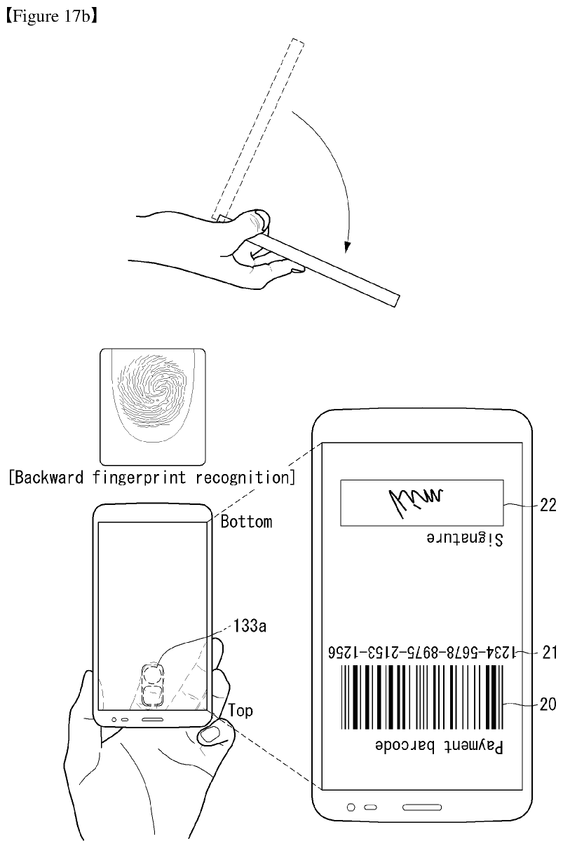

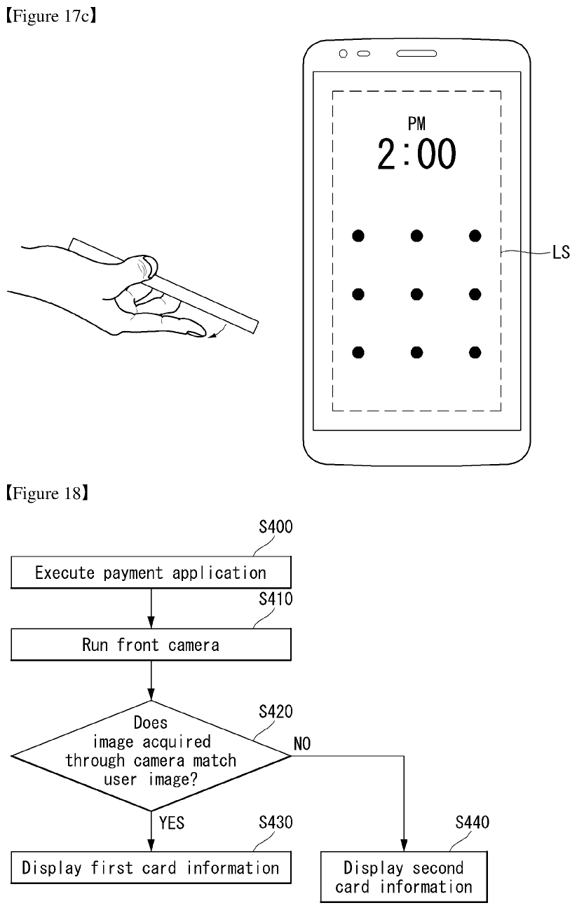

FIG. 16 is a flowchart of a control method for a mobile terminal according to a second exemplary embodiment of the present invention. FIGS. 17a to 17c are views for explaining examples of implementing the control method for a mobile terminal according to the second exemplary embodiment of the present invention.

The control method for a mobile terminal according to the second exemplary embodiment of the present invention may be implemented on the mobile terminal 100 explained with reference to FIGS. 1 to 3. Also, the second exemplary embodiment of the present invention may be implemented based on the foregoing first exemplary embodiment or in combination with at least some configurations of the first exemplary embodiment. The control method for a mobile terminal according to the second exemplary embodiment of the present invention and the operation of the mobile terminal 100 for implementing the same will be described below in details with reference to the required drawings.

Referring to FIG. 16, the controller 180 may execute a payment application (S300). As the payment application is executed, the controller 180 may perform user authentication (e.g., fingerprint authentication) (S310).

An interface for fingerprint authentication may be provided as stated previously. The following description will be given on the assumption that a fingerprint input is received through a fingerprint input unit (panel) provided on the rear input unit (133a of FIG. 1c).

The controller 180 may determine whether the direction of fingerprint recognition is backward or forward (S320). The direction of fingerprint recognition will be described with reference to FIGS. 17a and 17b.

As for the direction of fingerprint recognition, as illustrated in FIG. 17a, if a user's fingerprint is inputted through the rear input unit 133a while the user is gripping the mobile terminal 100 in a normal direction (from top to bottom), a process of recognizing a fingerprint pattern through the fingerprint input unit may be defined as forward fingerprint recognition. Also, as shown in FIG. 17b, if a user's fingerprint is inputted through the rear input unit 133a while the user is gripping the mobile terminal 100 in a backward direction (from bottom to top), a process of recognizing a fingerprint pattern through the fingerprint input unit may be defined as backward fingerprint recognition.

That is, the controller 180 may identify the orientation of the display 151 as a first direction or second direction by analyzing the fingerprint pattern inputted through the fingerprint input unit (rear input unit 133a).

Therefore, if the direction of fingerprint recognition is identified as a normal direction, the controller 180 may display the first card information on the touchscreen 151, and if the direction of fingerprint recognition is identified as backward, the controller 180 may display the second card information on the touchscreen 151.

It is apparent that the second exemplary embodiment of the present invention may be carried out in combination with the foregoing first exemplary embodiment. For example, if the direction of fingerprint recognition is backward and the orientation of the display 151 is the first direction, the controller 180 may display either the first card information or the second card information on the touchscreen 151.

Meanwhile, when the direction of fingerprint recognition is backward, the controller 180 may display the second card information on the touchscreen 151 only while an input on the fingerprint input unit is maintained. If the input on the fingerprint input unit is released, the controller 180 may make the second card information disappear or display the first card information, instead of the second card information, on the touchscreen 151.

Meanwhile, referring to FIG. 17c, when the direction of fingerprint recognition is backward and the orientation of the display 151 is the second direction, if the input on the fingerprint input unit is released, the mobile terminal 100 may be switched to a locked state, and a lock screen may be displayed on the touchscreen 151.

The foregoing first and second exemplary embodiments of the present invention have been described based on fingerprint recognition as an example of user authentication. However, the user authentication method is not limited to the above example, but may be modified in various ways. For example, user authentication may be performed using images acquired through a camera, which will be described below through a third exemplary embodiment of the present invention.

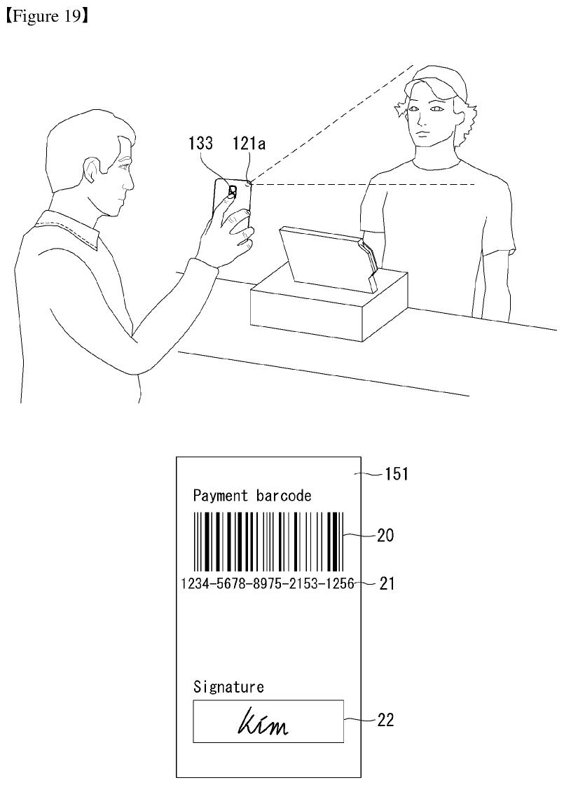

FIG. 18 is a flowchart of a control method for a mobile terminal according to a third exemplary embodiment of the present invention. FIG. 19 is a view for explaining an example of implementing the control method for a mobile terminal according to the third exemplary embodiment of the present invention.

The control method for a mobile terminal according to the third exemplary embodiment of the present invention may be implemented on the mobile terminal 100 explained with reference to FIGS. 1 to 3. Also, the third exemplary embodiment of the present invention may be implemented based on the foregoing first exemplary embodiment and/or second exemplary embodiment or in combination with at least some configurations of the first exemplary embodiment and/or second exemplary embodiment. The control method for a mobile terminal according to the third exemplary embodiment of the present invention and the operation of the mobile terminal 100 for implementing the same will be described below in details with reference to the required drawings.

Referring to FIG. 18, the controller 180 may execute a payment application (S400).

As the payment application is executed, the controller 180 may perform user authentication (e.g., face recognition). For user authentication, the controller 180 may run the camera (121a of FIG. 1b) provided on the front of the body (S410).

The controller 180 may perform user authentication using face recognition by determining whether an image acquired through the camera matches a registered user image or not (S420). Once the user authentication using face recognition is properly completed (S420:YES), the controller 180 may display the first card information on the touchscreen 151. If the user authentication using face recognition is not properly completed (S420:NO)—that is, the image acquired through the camera 121a does not match the registered user image, the controller 180 may display the second card information on the touchscreen 151.

Referring to FIG. 19, if the display 151 is oriented toward the other party other than the user of the mobile terminal 100, the image acquired through the camera 121a corresponds to the other party's face. As such, the controller 180 may display the second card information on the touchscreen 151 after the user authentication using face recognition.

It is apparent that the third exemplary embodiment of the present invention may be carried out in combination with the foregoing first exemplary embodiment and/or second exemplary embodiment. For example, even if the orientation of the display 151 is identified by the position detection sensor when a payment application is executed, and a user authentication process using fingerprint authentication is properly performed, face recognition may be performed using an image acquired through the camera 121a, and the first card information or second card information may be selectively provided based on the result of the face recognition.

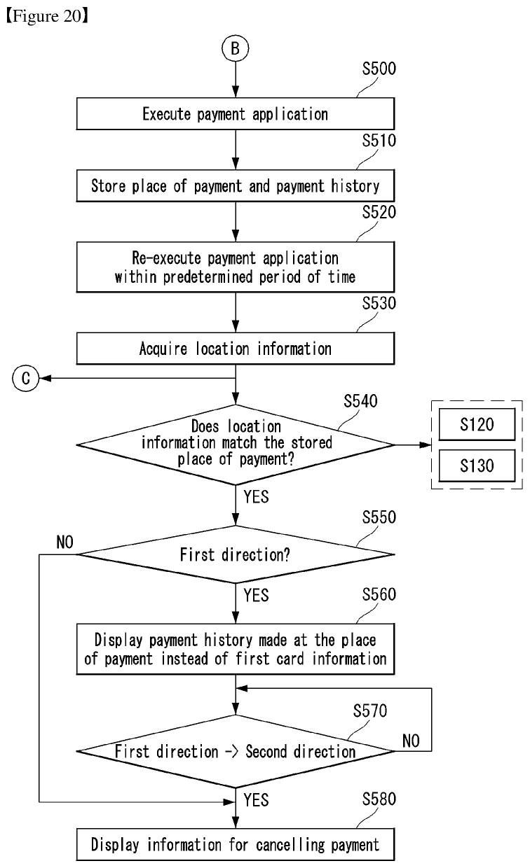

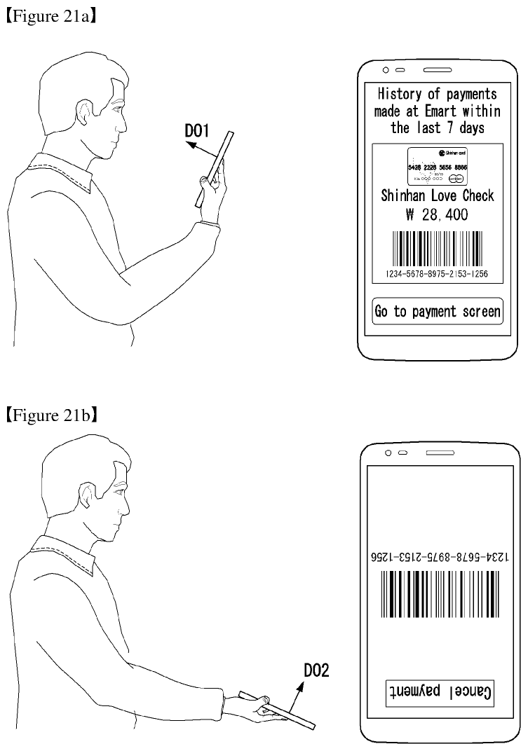

FIG. 20 is a flowchart of a control method for a mobile terminal according to a fourth exemplary embodiment of the present invention. FIGS. 21a and 21b are views for explaining examples of implementing the control method for a mobile terminal according to the fourth exemplary embodiment of the present invention.

The control method for a mobile terminal according to the fourth exemplary embodiment of the present invention may be implemented on the mobile terminal 100 explained with reference to FIGS. 1 to 3. Also, the fourth exemplary embodiment of the present invention may be implemented based on the foregoing first exemplary embodiment, second exemplary embodiment, and/or third exemplary embodiment or in combination with at least some configurations of the first exemplary embodiment, second exemplary embodiment, and/or third exemplary embodiment. The control method for a mobile terminal according to the fourth exemplary embodiment of the present invention and the operation of the mobile terminal 100 for implementing the same will be described below in details with reference to the required drawings.

Referring to FIG. 20, the controller 180 may execute a payment application (S500). When performing a payment function using the payment application, the controller 180 may store a place of payment and a payment history together in the memory 170 (S510).

Afterwards, the controller 180 may re-execute the payment application within a predetermined period of time (S520). For example, after making a payment through the payment application at a first place, the user may visit the first place again after a certain period of time and execute the payment application.

The controller 180 may acquire current location information of the mobile terminal 100 through a location information module (S530).

Referring to FIGS. 21a and 21b, if a location acquired through the location information module matches the place of payment where a previous payment was made through the payment application (S540:YES), the controller 180 may identify the orientation of the display 151 through the position detection sensor (S550). If the orientation of the display is identified as the first direction, the previous payment history made at the place of payment, instead of the first card information, may be displayed on the touchscreen 151 (S560).

Upon detecting through the position detection sensor that the orientation of the display is switched from the first direction to the second direction (S570:YES), the controller 180 may display on the touchscreen 151 card information for cancelling the payment at the place of payment (S580).

This may save the trouble of looking up the previous payment history on the mobile terminal 100 in order to cancel the payment.

Moreover, if the location does not match the place of payment where the previous payment was made through the payment application (S540:NO), the controller 180 may selectively display the first card information or second card information on the touchscreen 151 in the orientation of the display 151 (S120 and S130).

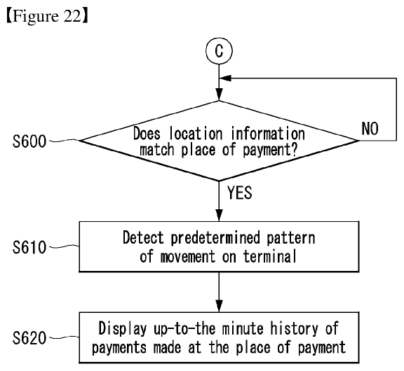

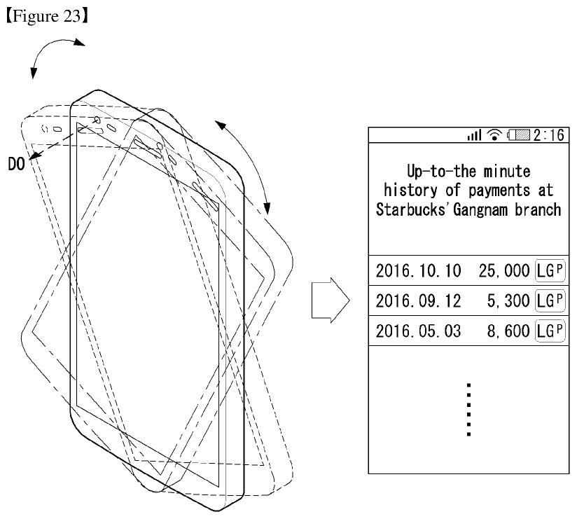

FIG. 22 is a flowchart of a control method for a mobile terminal according to a fifth exemplary embodiment of the present invention. FIG. 23 is a view for explaining an example of implementing the control method for a mobile terminal according to the fifth exemplary embodiment of the present invention.

Referring to FIG. 22, in the fourth exemplary embodiment of the present invention, if the acquired location information matches the place of payment where a previous payment was made through a payment application (S600:YES), the controller 180 may detect a predetermined pattern of gesture (movement) on the mobile terminal 100.

For example, referring to FIG. 23, the predetermined pattern of movement may be a movement detected when a gesture of shaking the mobile terminal 100 to the left and right a given number of times. Upon detecting the predetermined pattern of movement, the controller 180 may display on the touchscreen 151 an up-to-the minute history of payments made at the place of payment. That is, based on the predetermined pattern of movement, the controller 180 may construe the user as having the intention of requesting a history of payments made at the current place, rather than making an additional payment through the payment application.

Needless to say, it can be assumed that, in the fifth exemplary embodiment of the present invention, the predetermined pattern of movement is detected when the orientation of the display 151 is maintained in the first direction.

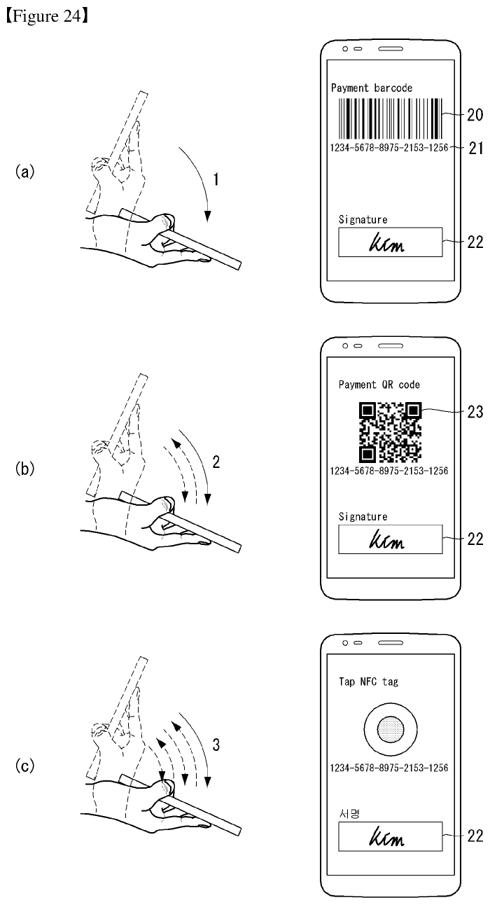

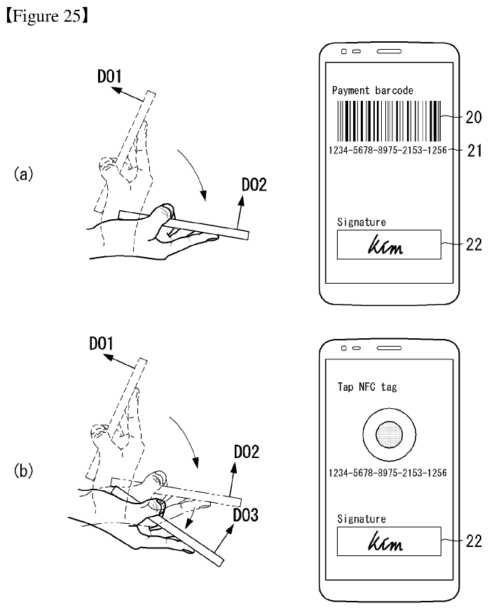

FIGS. 24 and 25 are views for explaining an example of implementing the control method for a mobile terminal according to a sixth exemplary embodiment of the present invention.

Referring to FIG. 24, according to the sixth exemplary embodiment of the present invention, when a payment application is executed, a different method of payment may be applied depending the number of changes in the movement of the mobile terminal 100. The method of payment may include at least one among near field communication (NFC) payment, magnetic reading type payment, or barcode scanning payment.

For example, upon detecting that the mobile terminal 100 is tilted once in a predetermined direction when the payment application is executed (that is, upon detecting that the orientation of the display is switched from the first direction to the second direction), the controller may display the second card information, instead of the first card information, on the touchscreen 151. Here, the second card information may include an interface for barcode payment.

In this instance, upon detecting that the orientation of the display of the mobile terminal 100 is tilted in the first direction and then in the second direction, the controller 180 may display on the touchscreen 151 an interface for QR code payment, instead of an interface for barcode payment.

In this instance, upon detecting a change in the aforementioned pattern of movement again, the controller 180 may change the method of payment to NFC payment but not to scanning payment and provide an interface for making payment via NFC to the touchscreen 151.

Therefore, according to the sixth exemplary embodiment of the present invention, any one among the first card information, the second card information, and an interface for a different method of payment may be selectively provided to the touchscreen 151 based on the movement pattern of the mobile terminal 100.

Referring to FIG. 25, if the payment application is executed when the display orientation is the first direction DO1, and upon detecting a transition of the display orientation from the first direction DO1 to the second direction DO2, the controller 180 may display the second card information on the touchscreen 151 (see (a) of FIG. 25).

Meanwhile, upon detecting an additional transition of the display orientation from the second direction DO2 to a third direction DO3 through the position detection sensor, the controller 180 may change the method of payment and provide a user interface for the changed method of payment to the touchscreen 151 (see (b) of FIG. 25).

Here, the first direction DO1 may be a direction in which the display is oriented at a point in time when the payment application is executed, and the second direction DO2 may be a direction in which the display is oriented when tilted at a first angle from the first direction DO1 with respect to one axis of the body. As explained with reference to FIG. 11b, the first angle may refer to an angle at which the mobile terminal 100 is tilted in such a way that the orientation of the display 151 ranges from DO3 to DO5.

The third direction DO3 may refer to a direction in which the display is oriented when tilted at more than the first angle from the second direction DO2. For example, referring to FIG. 11b, the first angle may refer to the amount of rotation that allows the mobile terminal 100 to be within the range between the third terminal position TP3 and the fifth terminal position TP5.

That is, the first direction may be a direction in which the display 151 is oriented toward the user of the mobile terminal 100, and the second direction and the third direction may refer to a direction in which the display 151 is oriented toward the other party facing the user of the mobile terminal 100. Also, the third direction may refer to a direction in which the display 151 is oriented when tilted further from the second direction toward the other party.

As explained with reference to FIG. 24, different interfaces are used depending on the method of payment.

It should be noted that the aforementioned movement pattern of the mobile terminal 100 is only an example but not restrictive.

The present invention described above may be implemented as a computer-readable code in a program recording medium. Computer-readable recording media include all types of recording devices on which data readable by a computer system may be stored. Examples of computer readable media include HDD (Hard Disk Drive), SSD (Solid State Disk), SDD (Silicon Disk Drive), ROM, RAM, CD-ROM, magnetic tape, floppy disk, optical data storage device, and the like, and may be implemented in the form of carrier waves (e.g., transmission through Internet). Moreover, the computer may include the controller 180 of the terminal. Therefore, the detailed description described above should not be construed as limiting. The scope of the present disclosure should be decided based on the reasonable interpretation of the appended claims and all modifications falling within the equivalent ranges of the disclosure are included in its scope.

1. A mobile terminal comprising:
a body;
a display provided on the front of the body;
a position detection sensor for detecting the position of the body or a change in the position of the body;
a memory for storing card information for executing a payment function; and
a controller that, when the payment application is executed, identifies the orientation of the display as a first direction or second direction through the position detection sensor, and that displays first card information on the display in the first direction and displays second card information, which is created by encrypting at least part of the first card information, on the display in the second direction.

2. The mobile terminal of claim 1, wherein the orientation of the display is a direction perpendicular to the plane of the display.

3. The mobile terminal of claim 1, wherein the first direction is a direction in which the display is oriented at a point in time when the payment application is executed, and the second direction comprises at least one between a direction in which the display is oriented when tilted at a predetermined angle from the first direction with respect to one axis of the body and substantially the opposite direction of the first direction.

4. The mobile terminal of claim 1, wherein the first card information comprises at least one among a card company, a card number, a card validity date, the name of the card holder, and balance information, and the second card information comprises at least one between information created by encrypting some of the first card information required for payment and a signature field.

5. The mobile terminal of claim 1, wherein the second card information comprises at least one between a barcode and QR code which are provided by encrypting the information required for payment.

6. The mobile terminal of claim 5, wherein, if the orientation of the display is switched from the second direction to the first direction when the second card information is displayed, the controller displays the first card information, instead of the second card information, on the display.

7. The mobile terminal of claim 1, wherein, if card information on a plurality of cards is registered in the memory, the controller scrolls first card information on each of the plurality of cards through a predetermined input in the first direction and displays the same on the display.

8. The mobile terminal of claim 1, further comprising a fingerprint input unit, wherein, when the payment application is executed, if an authentication key inputted through the fingerprint input unit matches a predetermined authentication key, the controller displays the first card information on the display in the first direction, and, if the orientation of the display is switched from the first direction to the second direction while the input on the fingerprint input unit is maintained, the controller displays the second card information on the display.

9. The mobile terminal of claim 8, wherein the controller displays the second card information on the display while the input on the fingerprint input unit is maintained in the second direction.

10. The mobile terminal of claim 8, wherein, if the input on the finger input unit is released, the controller switches the mobile terminal to a locked state and displays a lock screen on the display.

11. The mobile terminal of claim 8, wherein, if an authentication key is inputted through the fingerprint input unit when the body is at a first terminal position, the controller displays the first card information on the display, and if the authentication key is inputted through the fingerprint input unit when the body is at a second terminal position, the controller displays the second card information on the display.

12. The mobile terminal of claim 8, wherein the fingerprint input unit comprises at least one among a key provided on the front of the body, a key provided on the side, a key provided on the rear, and at least some region of a panel of the display.

13. The mobile terminal of claim 1, further comprising a location information module for acquiring location information of the mobile terminal,
wherein, if the payment function is performed when the second card information is displayed on the display, the place of payment acquired through the location information module, along with a payment history, is stored in the memory.

14. The mobile terminal of claim 13, wherein, if it is determined that the payment application is executed at the place of payment within a predetermined period of time after a payment is made at the place of payment, the controller displays the payment history made at the place of payment, instead of the first card information, on the display in the first direction.

15. The mobile terminal of claim 13, wherein, upon detecting that the orientation of the display is switched to the second direction while the payment history is displayed on the display, the controller displays card information for cancelling the payment on the display.

16. The mobile terminal of claim 1, further comprising a location mobile terminal for acquiring location information of the mobile terminal,
wherein, upon detecting a predetermined pattern of movement on the body when the payment application is executed and the orientation of the display is maintained in the first direction, the controller displays on the display an up-to-the minute history of payments made at the placement of payment acquired through the location information module.

17. The mobile terminal of claim 1, wherein, if the orientation of the display is switched from the second direction to a third direction, the controller changes the method of payment and displays a user interface for the changed method of payment on the display.

18. The mobile terminal of claim 17, wherein the method of payment comprises at least one among near field communication (NFC) payment, magnetic reading type payment, and barcode scanning payment.

19. The mobile terminal of claim 1, further comprising a camera,
wherein, upon completion of user authentication using an image acquired through the camera when the payment application is executed, the controller displays the first card information on the display in the first direction.

20. The mobile terminal of claim 1, wherein the position detection sensor comprises at least one between an acceleration sensor and a gyro sensor.

21. The mobile terminal of claim 1, wherein the display comprises a touch panel,
wherein the controller disables a touch response function of the touch panel in the second direction.

22. A method for controlling a mobile terminal, the method comprising:
executing a payment application;
identifying the orientation of a display provided on the front of a body as a first direction or second direction through a position detection sensor;
displaying first card information on the display in the first direction; and
if the orientation of the display is switched from the first direction to the second direction, displaying second card information, which is created by encrypting at least part of the first card information, on the display.
